(19) United States
(12) Patent Application Publication
(10) Pub. No.: US 2010/0125807 A1
(43) Pub. Date: May 20, 2010

(54) Electronic Scrolling Text Display

(76) Inventors: Jack Edward Easterday, Emeryville, CA (US); David Mark Alter, Berkeley, CA (US)

Correspondence Address: Gard and Kaslow LLP, One 1st Street, Suite 9, Los Altos, CA, 94022, US

(21) Appl. No.: 12/273,041

(22) Filed: Nov. 18, 2008

(51) Int. Cl. G06F 3/048

(52) U.S. Cl. 715/785

(57) ABSTRACT

An improved electronic display of text in a vertical or horizontal continuously scrolling fashion is provided. A viewer can read the displayed text without the distractions of awkward user interface mechanisms or the start and stop interruptions of page changes. To facilitate differing viewer needs, the viewer can alter the scrolling speed as desired. The display intensity of the text output for display can be varied to assist the viewer's focal point in the text as a further aid to reading the text. The viewer can pause the scrolling text, can jump to another point in the text, can bookmark the scrolling text and can edit the scrolling text.

### BACKGROUND

1. Field of the invention

The invention is in the field of electronic imaging and more specifically in the field of electronic display of text.

2. Related Art

Reading literacy has flourished since Gutenberg's invention of the printing press almost six hundred years ago. The industrial revolution made books economical to the masses thus leading to their widespread availability in the late 1800's. Whereas reading used to be limited to careful study of religious or scholarly works, today it ranges from academic works to business documents, from serious publications to tabloid periodicals, from classic literature to pulp novels.

As significant, the form of the document has also changed. In Gutenberg's day, reading was limited to viewing paper or cloth impregnated with ink. Today, we read a wide variety of display devices from televisions to computer screens to handheld devices such as cell phones and personal digital assistants (PDA's). This has led to the creation of other types of documents to read such as word processed documents, emails and text messaging.

Books produced by Gutenberg's printing press allowed a viewer to read a single page of text at a time or at most two pages at a time if the pages were printed on both sides. The viewer then had to turn the page in order to be able to view the next page for reading. This single page-at-a-time paradigm was necessary due to the physical constraints of the printed page since not all text of any reasonable length could fit on a single page.

Of note is that despite the growth in literacy, the widespread availability of books, and the proliferation of electronic display devices, the basic mechanics of reading have not fundamentally changed in all this time. One still reads a page at a time before turning to the next page to continue reading. This was not seen as a limitation when reading a physical book and conveniently allowed simple flipping back and forth between pages as desired.

Modern electronic equivalents to the book have followed the same single page-at-a-time paradigm despite not having the same physical constraints as books. Yet the mechanics of page flipping are not the same with electronic devices and other constraints inherent in these devices make this paradigm problematic.

Examples of such modern electronic devices are the Amazon “Kindle” and the Sony “Reader”, loosely depicted as display device 101 in FIG. 1, which are touted as being revolutionary for their high-resolution screen that looks and reads like real paper. However, the breakthrough of these devices is the legibility of the display rather than how the viewer interacts with the device when reading the displayed text.

Following the same page-at-a-time paradigm creates a host of problems when using an electronic display to read text. A viewer must operate some awkward user interface when desiring to change pages. Unlike the reflexive, almost unconscious, physical act of turning a page in a book, locating and pressing buttons on an electronic device in order to have a new page of text displayed can be a very distracting operation. This problem is made worse by the time lag of an electronic reader while it slowly refreshes an entire screen page of text.

This leads to the problem of a viewer struggling to maintain context in the electronic text being read. With a book, the viewer can simply flip back and forth between pages to keep context within the text being read. With an electronic display having an awkward user interface and incurring display refresh time lags, context can easily be lost.

A further complaint about these modern electronic reader devices is that they are yet one more piece of electronic equipment for users to carry around. Already loaded down with laptops, cell phones, PDA's, etc., the prospect of carrying another device, particularly one that has batteries needing to be recharged, becomes an increasing burden.

Today, people are trying to read text displayed on cell phones and other handheld devices with physically smaller display sizes, each loosely represented as device 103 in FIG. 1. The small display size of such devices has meant even fewer words of text can be displayed. Oftentimes only a sentence or perhaps two of a multiple page document can be displayed and seen at a time. Maintaining context then becomes even more difficult. It is as if one is looking through a keyhole at a small portion of an entire page of text while trying to move the book around on the other side of the keyhole in a hopeless attempt at trying to mentally piece together the entire page of text. Sadly, such mental gymnastics have become the norm as more and more people attempt to view web pages and word processing documents on cell phones and other handheld devices.

Bill Gates, co-founder of Microsoft, once said that “The first rule of any technology used in a business is that automation applied to an efficient operation will magnify the efficiency. The second is that automation applied to an inefficient operation will magnify the inefficiency.” This statement aptly fits the modern automated world filled with increasingly smaller electronic displays in the form of cell phones, PDA's, etc., where the inefficiencies of page-at-a-time document viewing have become magnified.

What is needed is an improved way to view electronically displayed text, particularly with smaller display devices, that is simpler and more user friendly.

### SUMMARY

An improved electronic display text output that makes reading simpler, easier, more intuitive, more comfortable, and with less distraction is shown and described herein with reference to a number of specific embodiments.

In one embodiment is a method of displaying text comprising receiving formatted text, converting the formatted text to plain text, outputting for display the plain text as one or more scrolling lines of text with a predetermined scrolling speed, receiving an input from a viewer of the displayed one or more scrolling lines of text to change the scrolling speed, and changing the scrolling speed of the output one or more scrolling lines of text according to the received viewer input.

In another embodiment is computer readable medium having computer-executable instructions for performing a method comprising receiving formatted text, converting the formatted text to plain text, outputting for display the plain text as one or more scrolling lines of text with a predetermined scrolling speed, receiving an input from a viewer of the displayed one or more scrolling lines of text to change the scrolling speed; and changing the scrolling speed of the output one or more scrolling lines of text according to the received viewer input.

### BRIEF DESCRIPTION OF THE DRAWING

FIG. 1 is a depiction of a prior art electronic reader device and a prior art cell phone or other handheld device;

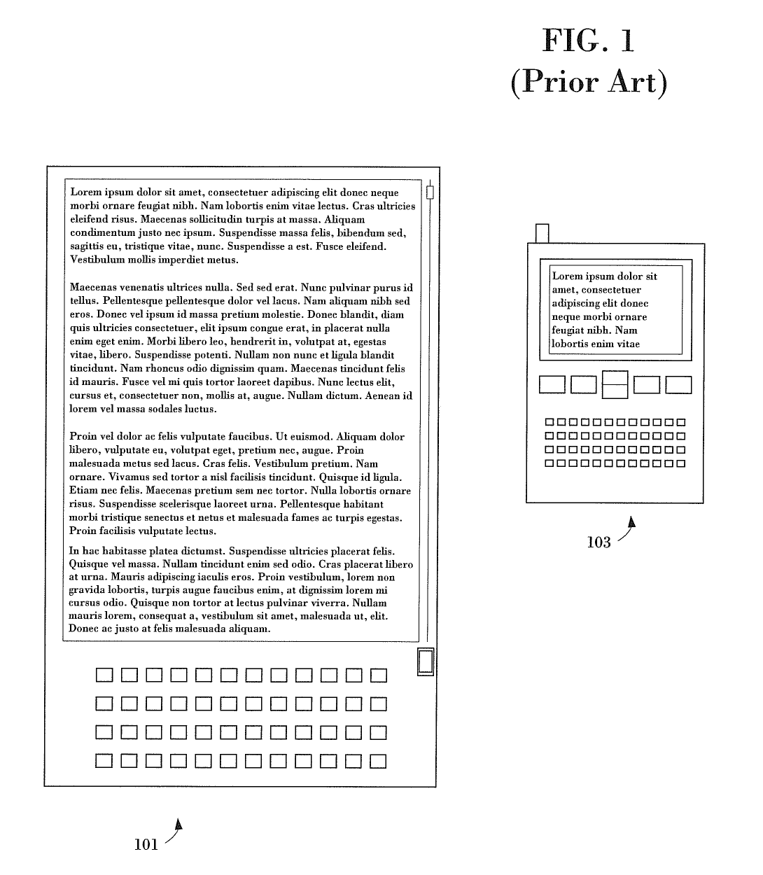

FIG. 2 is a series of consecutive screen shots showing a vertically scrolling text display according to one embodiment of the invention;

FIG. 3 is a series of consecutive screen shots showing a horizontally scrolling text display according to another embodiment of the invention;

FIG. 4 is a series of consecutive screen shots showing a vertically scrolling text display originating with text having have an embedded image, according to yet another embodiment of the invention; and

FIG. 5 is a flowchart depicting an exemplary method according to an embodiment of the invention, with various optional steps as described.

### DETAILED DESCRIPTION

What is provided is an improved electronic display of text that makes reading simpler, easier, more intuitive, and with less distraction than prior approaches. The text is output for display in a continuous scrolling fashion. This allows a viewer to continuously read without the distractions of user interface mechanisms or the start and stop interruptions and delays of page changes. The text output for display can scroll vertically or horizontally, as explained elsewhere herein.

A viewer of the displayed text can adjust the speed of the scrolling text. In this way, the viewer can control the rate at which the text is scrolling while the text continues to scroll. Viewers who are faster readers can speed up the scroll speed and viewers who are slower readers can slow down the scroll speed. Similarly, scroll speed can be slowed down for more complex or difficult textual passages and sped up for easier or simpler textual passages, as controlled by the viewer.

The viewer can control the scrolling speed so that the displayed text simply flows at a rate that is comfortable for the viewer to read. This allows a viewer to more passively interact with the electronic display in that it can even be operated as a “set and forget” scrolling operation. The viewer can also control the scrolling speed so that the displayed text flows at a faster rate than is comfortable for the viewer to read. This can be useful for a viewer wishing to train oneself to read at a faster rate.

The electronically displayed text can originate from any form of text including previously formatted text. For example, the previously formatted text may come from a viewer who copied it from some electronic document, email or webpage. Similarly, the viewer may simply provide a pointer or link to such a document, email or webpage containing the formatted text. As such, any existing or available electronic text can be accommodated including text having any preexisting formatting. The existing or available electronic text can also include image information which is handled as explained elsewhere herein.

A viewer of the displayed text can adjust the font size of the scrolling text, pause the scrolling text, jump to another place in the text, bookmark a location in the scrolling text, and perform editing functions on the scrolling text, etc., all as described further herein.

A preferred embodiment is implemented in software stored on or loaded into a computer readable medium such as an optical disc, a hard drive, a flash drive, Read-Only Memory (ROM), Random Access Memory (RAM), working memory, system memory, cache memory, etc. The software is executable on essentially any processor in any hardware configuration. Although not limited as such, one preferred implementation is with a device having a physically small electronic display. Examples include handheld devices such as cell phones, PDA's, MP3 players, Global Positioning Systems (GPS's), game players, etc. One advantage of such implementation is that it avoids the viewer having to carry a specialized device for text reading and, instead, can utilize a device the viewer will already be carrying around.

In one embodiment, the text is displayed in a vertical scrolling line fashion similar to the credits shown at the end of a movie. In a further embodiment, the text in a middle vertical scrolling line is of normal text display intensity while the text in an upper and/or lower vertical scrolling line is grayed out. In this way, the viewer's eyes are drawn to the middle scrolling line of text rather than trying to scan an entire multiple line display all at once. Also, having the text scroll onto the screen displayed in a grayed out fashion before the text is displayed in a normal fashion can be more visually comfortable because it avoids possible visual irritation of a sudden flash of newly displayed text in a normal text display intensity.

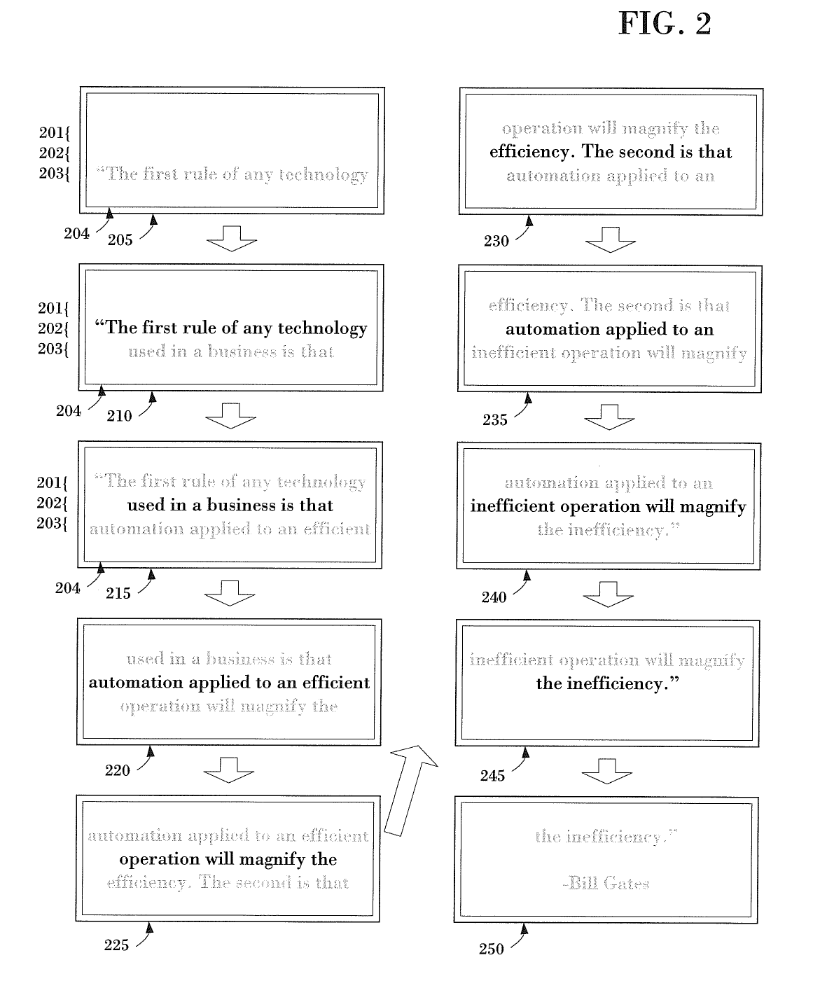

Referring now to FIG. 2, a series of consecutive display screen shots can be seen of a vertical scrolling text display embodiment. In this embodiment, the text being displayed scrolls vertically in a series of short single lines of text. Optionally, the scrolling text displayed in a lower region of the display area in a grayed out display mode is then displayed in a normal display mode while scrolling through the middle region of the display area, and is then again displayed in a grayed out display mode as it scrolls through the upper region of the display area. This gives the appearance of the displayed text entering the display area in a grayed out fashion, then becoming displayed in a normal fashion in the middle of the display area, and then returning to a grayed out fashion as it exits the display area.

In particular, screen shot 205 shows a first line of the Bill Gates text quote (“‘The first rule of technology”) having scrolled into a lower region 203 of the display area 204. This text is displayed in a grayed out fashion while in this lower region of the display area. As the first line of text scrolls vertically towards the middle region 202 of the display area 204 it transitions to being displayed in a normal display mode as seen in screen shot 210. Further, as can be seen in this screen shot, a second line of the Bill Gates quote (“used in a business is that”) has scrolled into the lower region 203 of the display area 204 and is displayed in the grayed out display mode.

Screen shot 215 shows the first line of text as it continues to scroll vertically into the upper region 201 of the display area 204 and transitions back to being displayed in a grayed out display mode. Likewise, the second line of text has moved into the middle region 202 of the display area 204 and has now transitioned to being displayed in a normal display mode. Further, a third line of text from the Bill Gates quote (“automation applied to an efficient”) has scrolled into the lower region 203 of the display area 204 and is displayed in the grayed out display mode.

This process continues as shown by screen shots 220-250 with each vertically scrolling line of text first being displayed in a grayed out display mode in the lower region 203 of the display area 204, then transitions to being displayed in a normal display mode in the middle region 202 of the display area 204, and then transitions to being displayed once again in a grayed out display mode in the upper region 201 of the display area 204.

Various alternative embodiments of this vertical scrolling operation can also be implemented. One alternative embodiment operates by having all displayed lines of scrolling text be in a normal display mode rather than transitioning from a grayed out display mode to a normal display mode and back to a grayed out display mode.

A further alternative embodiment (not shown) displays more than a total of three single lines of vertically scrolling as depicted in the screen shots of FIG. 2. Such alternative embodiment may generate a display of four, five, six, etc., lines of vertically scrolling text, as desired. In such further alternative embodiment, more than one line of vertically scrolling text in the middle region of the display area may optionally be displayed in a normal mode at the same time.

Another alternative embodiment (not shown) displays only a single line of vertically scrolling text which transitions from a grayed out display mode to a normal display mode and back to a grayed out display mode before a subsequent single line of vertically scrolling text is displayed in the same fashion. This embodiment operates as shown in FIG. 2 except as a single line of vertically scrolling text at a time. And in a still further alternative embodiment (not shown), each single line of vertically scrolling text may simply be continuously displayed in a normal display mode rather than transitioning from a grayed out display mode to a normal display mode and back to a grayed out display mode.

Another alternative embodiment (not shown) operates by having the vertical scrolling text scroll from an upper region of the display area to a middle region of the display area to a lower region of the display area. This could be useful for text in languages that are read from back to front of a book or document, as opposed to Western language books or documents which are typically read from front to back.

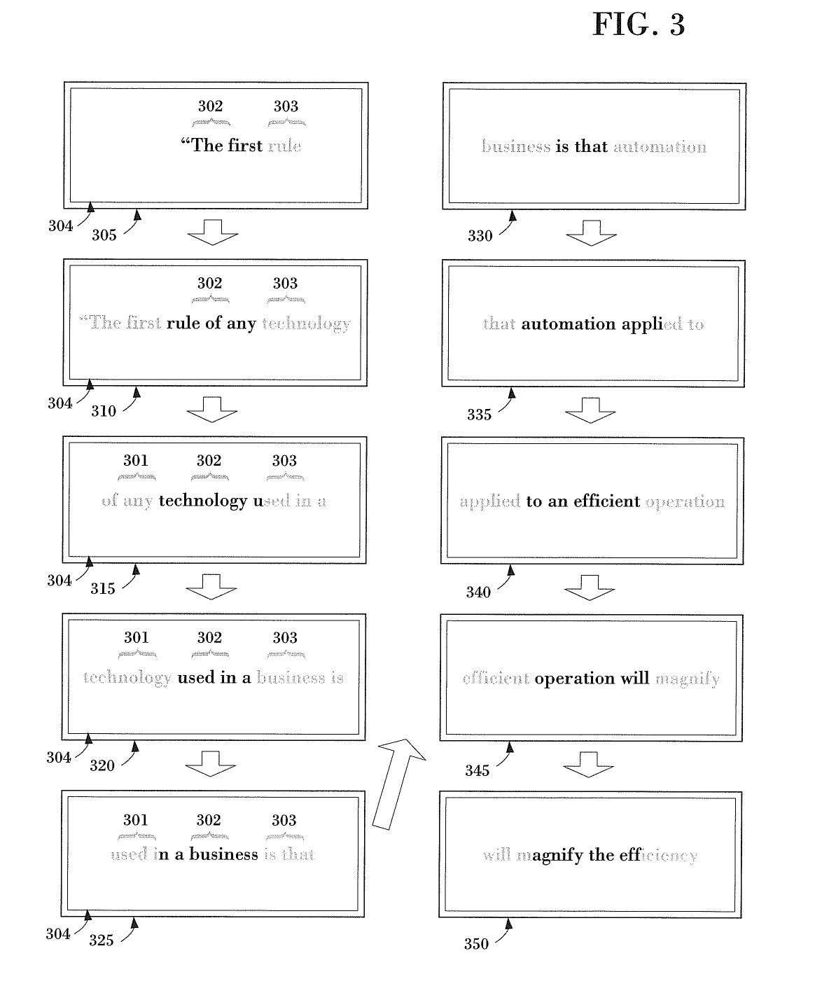

Referring now to FIG. 3, a series of consecutive screen shots can be seen showing a horizontal scrolling text display embodiment. In this embodiment, the text being displayed scrolls horizontally as a single line of text. Optionally, the text scrolls from one side of the display area in a grayed out mode, is then displayed in a normal mode while scrolling through a middle region of the display area, and is then again displayed in a grayed out display mode as it scrolls to the other side of the display area.

In particular, screen shot 305 shows the first few words of the Bill Gates text quote (“‘The first rule”) having scrolled from the right hand region 303 of the display area 304. As the text scrolls horizontally towards the middle region 302 of the display area 304 it transitions from being displayed in a grayed out display mode (the word “rule” in this screen shot) to being displayed in normal display mode (the words “‘The first” in this screen shot).

As the text continues to scroll horizontally it continues to transition from being displayed in a grayed out mode to being displayed in a normal mode to again being displayed in a grayed out mode. This can be seen in screen shot 310 where a first portion of text (“‘The first”), having scrolled horizontally to a left hand region 301 of the display area 304, is now displayed in a grayed out mode while a subsequent portion of text (“rule of any”), having scrolled horizontally to a middle region 302 of the display area 304, is now displayed in a normal mode. Likewise, a further subsequent portion of text (“technology”), having scrolled horizontally to a right hand region 303 of the display area 304, is displayed in a grayed out display mode.

This process continues as shown by screen shots 315-350, etc., with each portion of the horizontally scrolling line of text being displayed in a grayed out display mode in a right hand region 303 of the display area 304, then transitioning to being displayed in a normal display mode in a middle region 302 of the display area 304, and then transitioning to being displayed again in a grayed out display mode in a left hand region 301 of the display area 304.

It is to be understood that the transition from grayed out display mode to normal display mode and the transition from normal display mode back to grayed out display mode can be accomplished in a variety of ways. In one preferred embodiment such transitions occur at word boundaries while in another embodiment such transitions occur at an invisible boundary between the left hand region 301 and the middle region 302 and at an invisible boundary between the middle region 302 and the right hand region 303. A further embodiment handles transitions as a combination of these approaches depending upon the length of individual words in the text being displayed. A still further embodiment uses unequal lengths for the left hand region 301, the middle region 302 and the right hand region 303 (e.g., one embodiment maximizes the length of the middle region 302 while minimizing the lengths of the left hand region 301 and the right hand region 303).

Various alternative embodiments of the horizontal scrolling operation can also be implemented. One alternative embodiment (not shown) operates by having all portions the horizontal scrolling text being displayed in a normal display mode rather than transitioning from a grayed out display mode to a normal display mode and then back to a grayed out display mode. Another alternative embodiment (not shown) operates by having the horizontal scrolling text scroll from the left hand region through the middle region to the right hand region of the display area. This could be useful for text in languages that are read from right to left, as opposed to Western languages which are typically read from left to right.

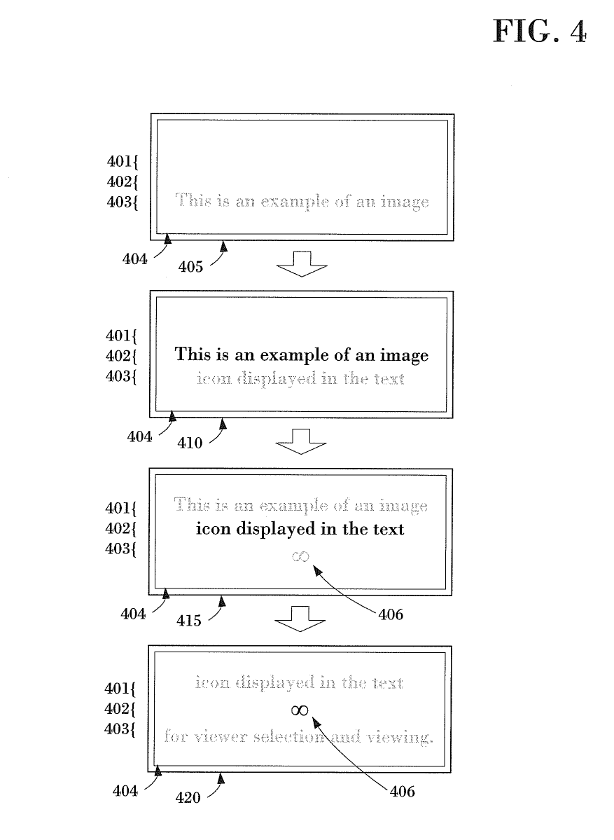

Referring now to FIG. 4, a series of exemplary consecutive screen shots can be seen showing a text display embodiment including scrolling text originating with text having an embedded image. In such a case, in one embodiment, the image embedded in the original text is replaced with an image icon in the scrolling text. The viewer, when seeing this image icon in the scrolling text, can then select the image icon via any known user interface mechanism thus causing the original embedded image to be displayed either momentarily or in a static fashion until the viewer indicates a desire to again view the image icon and scrolling text.

In this example, a first vertically scrolling line of text (e.g., “This is an example of an image”) can be seen in screen shot 405 in a lower region 403 of the display area 404 in a grayed out display mode. Then, in screen shot 410, the same line of text has scrolled vertically to a middle region 402 of the display area 404 and has transitioned to a normal display mode while a second line of text (“icon displayed in the text”) has scrolled vertically to the lower region 403 of the display area 404 in a grayed out display mode.

Subsequently, in screen shot 415, the first line of text has scrolled vertically to an upper region 401 of the display area 404 and has transitioned back to a grayed out display mode and the second line of text has scrolled vertically to the middle region 402 of the display area 404 and has transitioned to a normal display mode. Of note in this embodiment, rather than a third line of text scrolling vertically to the lower region of the display area, instead an image icon 406 is displayed there scrolling vertically in a grayed out mode.

Subsequently, in screen shot 420, the second line of text has scrolled vertically to the upper region 401 of the display area 404 and has transitioned back to a grayed out display mode and the image icon 406 has scrolled vertically to the middle region 402 of the display area 404 and has transitioned to a normal display mode. A third line of text (“for viewer selection and viewing.”) has scrolled vertically into the lower region 403 of the display area 404 in a grayed out display mode. As with the embodiment described with reference to FIG. 2, the process continues.

It is to be understood that whenever the image icon 406 is shown on the display area 404 the viewer can select the image icon 406 thus causing the original embedded image to be displayed. In one embodiment, if the viewer then closes the displayed embedded image, the scrolling text is once again displayed in the same fashion as before the viewer selected the image icon 406. In this way, original text containing embedded images as well as original text of a purely textual nature can each be accommodated.

It is also to be understood that although the image icon 406 is shown on its own scrolling line in the screen shots of FIG. 4, it can also be displayed within a scrolling line displaying text. It is still further to be understood that although FIG. 4 depicts a vertically scrolling text example, embedded images can be handled in essentially the same fashion with horizontally scrolling text where the embedded image icon scrolls horizontally across the display along with the plain text being displayed.

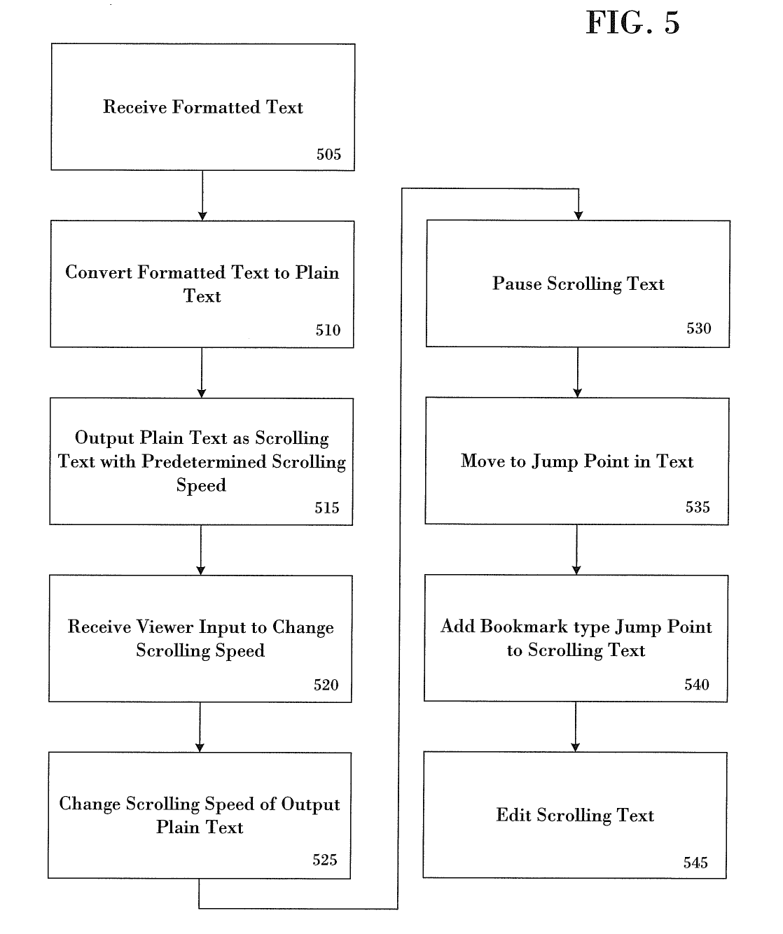

Referring now to FIG. 5, a flowchart depicting an exemplary embodiment of the method can be seen. This exemplary method begins by receiving the formatted text in step 505, converts the formatted text to plain text in step 510, outputs the plain text as scrolling text in step 515, receives input from the viewer to change the scrolling speed in step 520, changes the scrolling speed in step 525, pauses the scrolling text in optional step 530, moves the scrolling text to a jump point in optional step 535, adds a bookmark type jump point to the scrolling text in optional step 540, and edits the scrolling text in optional step 545.

Now reviewing each of these steps in more detail, the exemplary method begins with receiving the formatted text in step 505. As explained elsewhere herein, the formatted text may be provided by a viewer who copied it from an electronic document, email, webpage or any other source of electronic text. Alternatively, the viewer may simply provide a pointer or link to such a document, email, webpage, etc., containing the formatted text.

The formatted text is then converted to plain text in step 510 by removing much of its formatting. While paragraph breaks, capitalization and other punctuation may be preserved, other types of formatting such as font type, size, etc., is typically eliminated to create a more uniform, easy to display and read plain text. In one embodiment, text formatting such as bold, italics, underlining, etc., is preserved to aid in communicating the text author's original intent.

In an optional embodiment, any embedded images in the formatted text are replaced with image icons for use as described elsewhere herein.

The resulting plain text is then output for display as scrolling text with a predetermined scrolling speed in step 515. The predetermined scrolling speed can be a default value in the system or can be viewer specified. Viewer specification of the scrolling speed can be in the form of absolute values such as “200” words per minute or “60” lines of text per minute, for example, or can be in the form of relative values such as “slow”, “medium” or “fast” speed. Viewer specification or selection of these values can be via any known user interface.

Similarly, the plain text output for display as scrolling text can be in a predetermined font and font size. The predetermined font and font size can be default values used in the conversion step 510 or can be viewer specified. Viewer specification of the font and or font size can be in the form of absolute values such as “Times New Roman” font and “10” point font size, for example, or can be in the form of relative values such as “serif” or “sans serif” font or “small”, “medium” or “large” font size. Viewer specification or selection of these values can be via any known user interface.

In step 520, viewer input to change the scrolling text speed is received. The viewer input to change the scrolling text speed can operate in the same fashion as with specification of the predetermined scrolling speed described above, or can be via any other known user interface mechanism such as use of device buttons (up/down, plus/minus, page up/page down, etc.), scroll wheel, mouse movement, touch tablet, trackball, physical device movement when the device has a built-in accelerometer, etc.

In step 525, the scrolling speed of the output plain text is changed according to the viewer input received in step 520. In this way, the resulting displayed scrolling text is sped up or slowed down according to the viewer's wishes.

In optional step 530, upon receiving further input from the viewer, the scrolling text is paused. This is accomplished in one embodiment by continuously outputting for display the same portion or lines of text in the same display position and in the same display mode. Discontinuing the pause operation can occur due to receiving still further viewer input to resume scrolling, after a set period of time, or based on any other means known in the art for discontinuing a pause operation.

In optional step 535, upon receiving an input from a viewer to jump to another point in the plain text, the scrolling text output for display jumps to the other point in the plain text and outputs for display scrolling text from that point in the plain text. Points in the plain text to which a viewer may choose to jump include the beginning of the next paragraph, section, chapter, or any other natural demarcation in the original formatted text. To facilitate such jump points, these demarcations were noted when converting the formatted text to plain text in step 510, in any of various ways known in the art.

In an optional embodiment, rather than jumping to a jump point noted in the conversion process of step 510, a jump can simply be to a set number of lines forward or backward in the scrolling text. This is referred to herein as a “flick” or “flicker” type jump where the use simply wishes to “flick” the scrolling text ahead a few lines or “flick” back a few lines in the scrolling text. A viewer can indicate a desire to flick forward or backward via any known user interface.

In optional step 540, upon receiving an input from a viewer to save a bookmark in the plain text being output as scrolling text, a new type of jump point referred to herein as a bookmark type jump point is noted for that location in the plain text. Noting such a bookmark type jump point thus allows a viewer to later return to that point in the plain text output as scrolling text. More than one bookmark can be saved by a viewer and the viewer can give a name to each saved bookmark, as desired.

In optional step 545, the plain text output as scrolling text can be editing. Editing can take many different forms including highlighting portions of the plain text, adding notations to the plain text, altering the color of the scrolling text output for display, causing a reverse display (e.g., white text on a black background), as well as any other known text display mechanism known in the art including italics, bold, blinking text, etc.

An improved electronic display text output that makes reading simpler, easier, more intuitive, more comfortable, and with less distraction has been shown and described with reference to a number of specific embodiments. It is to be understood that other embodiments and implementations are possible within the spirit and scope of the present invention.

For example, in a still further alternative embodiment (not shown), a single horizontally scrolling line of text (e.g., as shown with reference to FIG. 3) is implemented and displayed in a diagonal fashion. In this embodiment, the horizontally scrolling line of text is output for display such that it scrolls from one corner to an opposing corner of the display rather than scrolling parallel to a side of the display or display area. Because the hypotenuse is the longest side of a right triangle, outputting the horizontally scrolling line of text for display across the diagonal maximizes the possible text display length thus allowing more characters to be displayed in the horizontally scrolling line of text.

As another example, in a yet further alternative embodiment, jump points can be combined with viewer edited plain text to allow, for example, a viewer to jump from one highlighted portion of text to a subsequent highlighted portion of text. This can be expanded to support a continuous scrolling display showing multiple viewer highlighted portions of text, one after the other.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, the description and the drawing should not be considered in a limiting sense, as it is understood that the present invention is in no way limited to only the embodiments illustrated.

What is claimed is:

1. A method of displaying text comprising:
receiving formatted text;
converting the formatted text to plain text;
outputting for display the plain text as one or more scrolling lines of text with a predetermined scrolling speed;
receiving an input from a viewer of the displayed one or more scrolling lines of text to change the scrolling speed; and
changing the scrolling speed of the output one or more scrolling lines of text according to the received viewer input.

2. The method of claim 1 wherein the step of receiving formatted text includes receiving from the viewer an indication of where the formatted text can be located.

3. The method of claim 1 wherein the step of receiving formatted text includes receiving from the viewer the formatted text.

4. The method of claim 1 wherein the one or more scrolling lines of text are a single line of scrolling text in a horizontal scrolling mode.

5. The method of claim 4 wherein the horizontal scrolling mode is from right to left.

6. The method of claim 1 wherein the one or more scrolling lines of text are in a vertical scrolling mode.

7. The method of claim 6 wherein the vertical scrolling mode is from bottom to top.

8. The method of claim 1 wherein the input from the viewer to change the scrolling speed is an input to increase the scrolling speed.

9. The method of claim 1 wherein the input from the viewer to change the scrolling speed is an input to decrease the scrolling speed.

10. The method of claim 1 wherein the one or more scrolling lines of text are at least three lines of text arranged in at least three horizontal rows.

11. The method of claim 10 wherein the at least three lines of text arranged in at least three horizontal rows includes an upper line of text in a grayed out display mode, a middle line of text in a normal display mode, and a lower line of text in a grayed out display mode.

12. The method of claim 11 wherein the upper line of text in a grayed out display mode is no longer output for display, the middle line of text in a normal display mode is output for display as the upper line of text in a grayed out display mode, the lower line of text in a grayed out display mode is output for display as the middle line of text in a normal display mode, and a new lower line of text is output for display in a grayed out display mode.

13. The method of claim 4 wherein the single line of scrolling text is output for display in a grayed out display mode in a left hand region, is output for display in a normal display mode in a middle region, and is output for display in a grayed out display mode in a right hand region.

14. The method of claim 1 wherein the step of converting the formatted text to plain text further comprises replacing an image included in the formatted text with an image icon in the plain text.

15. The method of claim 1 wherein the received formatted text includes at least one image, the method further comprises:
replacing the image in the formatted text with an image icon in the plain text;
the step of outputting for display the plain text further comprises outputting for display the image icon in the plain text;
receiving a request from the viewer of the displayed text to view the image replaced by the displayed image icon in the plain text; and
outputting for display the image.

15. A computer readable medium having computer-executable instructions for performing a method comprising:
receiving formatted text;
converting the formatted text to plain text;
outputting for display the plain text as one or more scrolling lines of text with a predetermined scrolling speed;
receiving an input from a viewer of the displayed one or more scrolling lines of text to change the scrolling speed; and
changing the scrolling speed of the output one or more scrolling lines of text according to the received viewer input.
